(19) United States
(12) Patent Application Publication
(10) Pub. No.: US 2013/0081265 A1
(43) Pub. Date: Apr. 4, 2013

(54) CONNECTOR TOOL

(71) Applicants: Owen R. BARTHELMES, Putnam Valley, NY (US); Hardik PARIKH, Danbury, CT (US); Michael A. HOYACK, Sandy Hook, CT (US); Ken CAPOZZI, Naugatuck, CT (US)

(72) Inventors: Owen R. BARTHELMES, Putnam Valley, NY (US); Hardik PARIKH, Danbury, CT (US); Michael A. HOYACK, Sandy Hook, CT (US); Ken CAPOZZI, Naugatuck, CT (US)

(73) Assignee: Amphenol Corporation, Wallingford, CT (US)

(21) Appl. No.: 13/250,338

(22) Filed: Sep. 30, 2011

(51) Int. Cl. H01R 43/26

(52) U.S. Cl. 29/747

(57) ABSTRACT

A tool for a connector that comprises a shaft and a clasp that has a substantially semi-cylindrical cross-sectional shape. The clasp includes a main body and opposite first and second ends. The first end is adapted to couple to the shaft and the second end is adapted to grasp a connector. The first end has a transverse diameter that is larger than a transverse diameter of the second end such that a step is disposed between the first and second ends that defines a recessed longitudinal portion along the main body configured to provide a low profile for clearance between adjacent connectors.

### FIELD OF THE INVENTION

The present invention relates to a tool for facilitating the installation and removal of a connector. More specifically, the tool is designed to grasp a connector while maintaining a low profile, thereby allowing use of the tool in high density applications.

### BACKGROUND OF THE INVENTION

Electrical connectors, particularly radio frequency (RF) connectors, provide couplings between electrical elements and/or devices. Many different types of electrical connectors exist and have been used to provide removable electrical connections between electronic elements and devices.

Conventional BNC coupling connector components facilitate attachment of coaxial electrical cables to electronic elements or devices. Typical BNC coupling connector components include a jack mounted to an electronic device or element and a plug connected to a cable. BNC connector components allow a reliable electrical connection to be made without the danger of the jack and plug connectors gradually becoming loose or becoming inadvertently unplugged. A bayonet mechanism of BNC coupling of connector pairs provides a positive engagement between the jack and plug connectors.

Often, multiple coupling connector components are positioned in close proximity to one another on electronic elements or devices, both vertically and horizontally, to provide a high density of connectors. However, there is often insufficient space for manual manipulation of the connectors to install and remove them. Therefore, a need exists for a connector tool that can be used in high density applications to both install and remove connector components.

### SUMMARY OF THE INVENTION

Accordingly, the present invention provides a tool for a connector that comprises a shaft and a clasp that has a substantially semi-cylindrical cross-sectional shape. The clasp includes a main body and opposite first and second ends. The first end is adapted to couple to the shaft and the second end is adapted to grasp a connector. The first end has a transverse diameter that is larger than a transverse diameter of the second end such that a step is disposed between the first and second ends that defines a recessed longitudinal portion along the main body configured to provide a low profile for clearance between adjacent connectors.

The present invention may also provide a tool for a connector that comprises a shaft and a clasp that has a substantially semi-cylindrical cross-sectional shape. The clasp includes a main body and opposite first and second ends. The first end is adapted to couple to the shaft and the second end is adapted to grasp a connector. The first end has a transverse diameter that is larger than a transverse diameter of the second end such that a step is disposed between the first and second ends that defines a recessed longitudinal portion along the main body configured to provide a low profile for clearance between adjacent connectors. An enlarged opening is disposed in the recessed longitudinal portion of the main body that is configured to receive at least a portion of the connector.

The present invention may also provide a tool for a connector that comprises a shaft and a clasp that has a substantially semi-cylindrical cross-sectional shape. The clasp includes a main body and opposite first and second ends. The first end is adapted to couple to the shaft and the second end is adapted to grasp a connector. The first end has a transverse diameter that is larger than a transverse diameter of the second end such that a step is disposed between the first and second ends that defines a recessed longitudinal portion along the main body configured to provide a low profile for clearance between adjacent connectors. The second end of the clasp includes at least first and second engagement members configured to engage the connector. The first and second engagement members are located about 180 degrees apart from one another.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a tool according to an exemplary embodiment of the present invention;

FIG. 2 is a perspective view of a clasp of the tool illustrated in FIG. 1;

FIG. 3A is a cross-sectional view of the clasp illustrated in FIG. 2;

FIG. 3B is a bottom plan view of the clasp illustrated in FIG. 2;

FIG. 3C is a top plan view of the clasp illustrated in FIG. 2;

FIG. 3D is a front side view of the clasp illustrated in FIG. 2; and

FIG. 4 is a partial perspective view of a high density of connectors, showing the tool grasping one of the connectors.

### DETAILED DESCRIPTION OF THE INVENTION

Referring to FIGS. 1, 2, 3A-3D, and 4, a connector tool 100 according to an exemplary embodiment of the present invention generally includes a shaft 102 having a handle 104 at one end and a clasp 106 for grasping a connector C (FIG. 4), such as a BNC connector or the like, at the other end. The handle 104 is configured to allow an operator to manually apply torque to the tool 100. The handle 104 may be made of any suitable material, such as extruded and polished resin. The shaft 102 can be made from any material that will transmit the applied torque with minimal loss of twisting force. The shaft 102 is preferably rigid and made of high strength tool steel with a corrosion-resistant clear zinc coating. In an exemplary embodiment, the shaft 102 has a circular cross-section; however the shaft 102 can be constructed to have any cross-sectional shape.

In an exemplary embodiment, the clasp 106 is configured to partially or fully encircle an exterior surface of the connector C. The clasp 106 could also be shaped for use with connectors that do not have a circular cross-section. Also, in an exemplary embodiment, the clasp 106 is made of the same material as the shaft 102, that is high strength tool steel with a clear corrosion-resistant zinc coating. However, the clasp may be constructed from any suitable material.

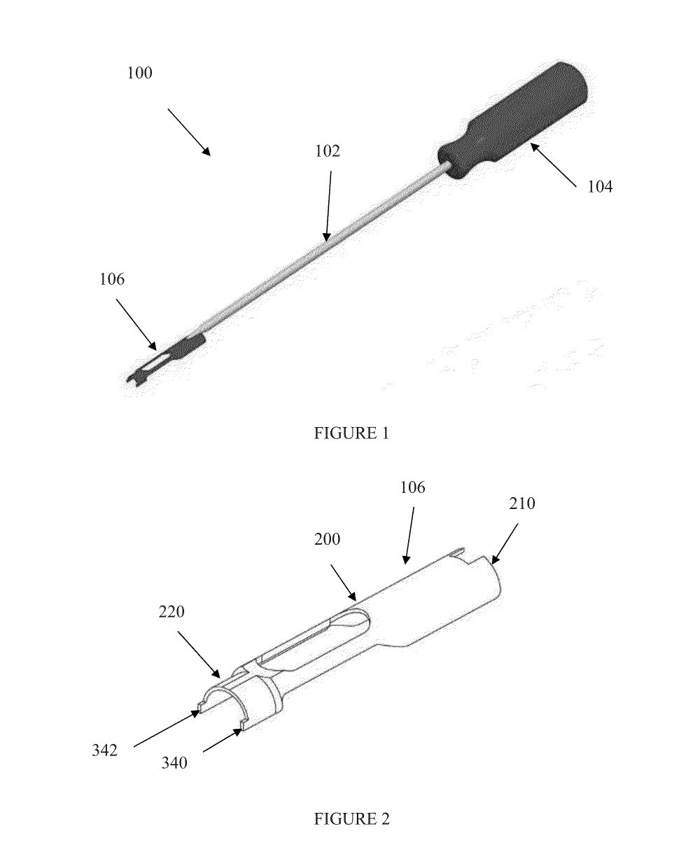

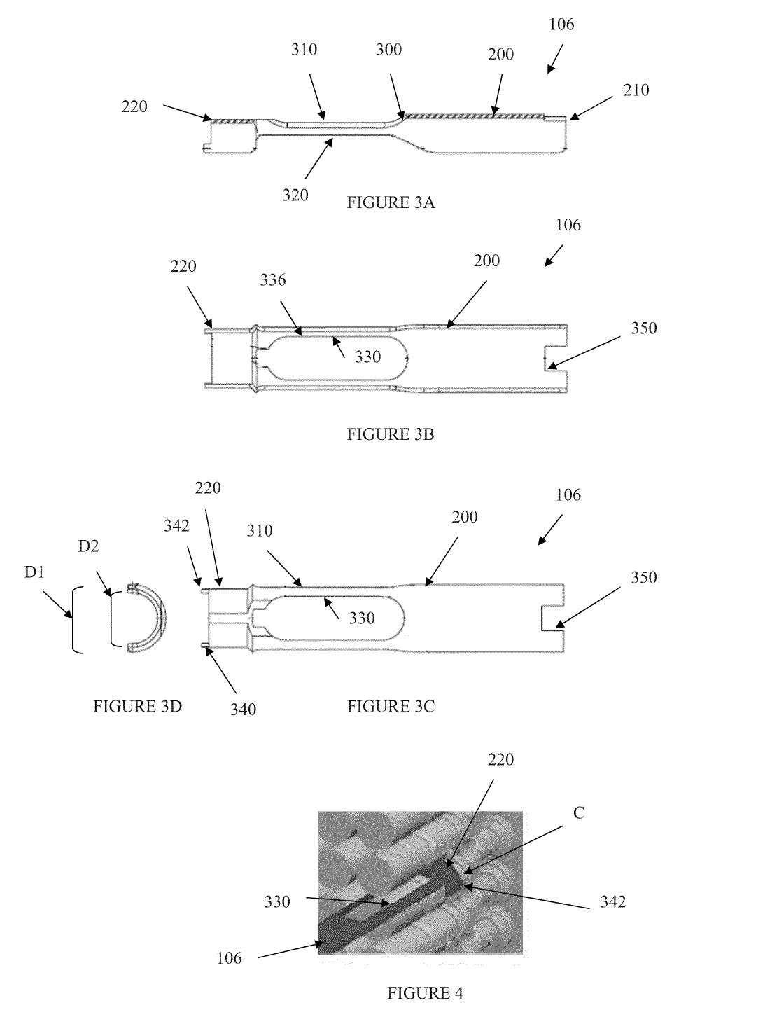

Referring to FIGS. 2 and 3A-3D, the clasp 106 generally includes a main body 200 with opposite first and second ends 210 and 220. The main body 200 may be generally semi-circular in cross-sectional shape, as seen in FIG. 3D, where the first end 210 is configured to couple to the shaft 102 and the second end 220 is shaped to grasp the connector C. The diameter D1 (transverse to a longitudinal axis of the clasp main body) of the first end 210 is greater than the diameter D2 of the second end 220, as seen in FIG. 3D, thereby creating a step 300, as seen in FIG. 3A, in the main body 200 between the first and second ends 210 and 220. The step 300 in turn defines a recessed longitudinal portion 310 of the clasp main body 200. The recessed longitudinal portion 310 provides a low profile to the clasp 106 so that the tool 100 may be inserted in between connectors, as seen in FIG. 4. A relief portion 320, as seen in FIG. 3A, may also be disposed opposite the recessed longitudinal portion 310 of the clasp 106, that also contributes to the low profile of the clasp 106.

As best seen in FIGS. 3B and 3C, an enlarged opening 330 is provided in the clasp main body 200 that defines first and second elongated arms 336 in the main body 200. The enlarged opening 330 is preferably provided in the recessed longitudinal portion 310 of the clasp main body 200 to allow rotation of the tool 100 when inserted between connectors. The enlarged opening 330 is preferably oval in shape; however the opening 330 may have any shape, such as rectangular. The opening 330 is adjacent the second end 220 of the clasp 106 so that a portion of the connector C can be received in the opening 330, as seen in FIG. 4.

Referring to FIGS. 2 and 3A-3C, the second end 220 of the clasp 106 may include one or more engagement members for detachably engaging the connector C such that when the tool is rotated, the connector C also rotates. In an exemplary embodiment, the engagement members are preferably first and second teeth 340 and 342 that extend from the second end 220. The teeth 340 and 342 are preferably located opposite each other, that is about 180° apart, as seen in FIG. 2. The teeth 340 and 342 may engage corresponding grooves, for example, of the connector C. When the teeth 340 and 342 are received in the grooves of the connector, the second end 220 of the clasp 106 partially encircles a portion of the connector C such that the tool 100 and connector C are positively engaged. Although two teeth 340 and 342 are preferred, any number of teeth may be used along with any number of corresponding grooves on the connector. Opposite the teeth at the first end 210 of the clasp 106, a notch 350 may be provided that accepts an end of the shaft 102, thereby coupling the shaft 102 and the clasp 106.

To detachably engage the tool 100 with the connector C, the operator aligns the teeth 340 and 342 with the corresponding grooves on the connector. The operator then slides the tool 100 longitudinally over the connector until that the teeth 340 and 342 are received in the grooves of the connector C. The operator then applies torque to the handle 104 and the torque is transmitted from the handle 104 through the shaft 102 to the clasp 106 that is at least partially encircling the connector. That torque rotates the tool 100 and the connector C together to either install or remove the connector. To disengage the tool 100 from the connector, the operator longitudinally slides the tool away from the connector C until the teeth 340 and 342 clear the grooves of the connector.

While a particular embodiment has been chosen to illustrate the invention, it will be understood by those skilled in the art that various changes and modifications can be made therein without departing from the scope of the invention as defined in the appended claims.

What is claimed is:

1. A tool for a connector, comprising:
a shaft; and
a clasp having a substantially semi-cylindrical cross-sectional shape, said clasp including a main body and opposite first and second ends, said first end being adapted to couple to said shaft, said second end being adapted to grasp a connector, said first end having a transverse diameter that is larger than a transverse diameter of said second end such that a step is disposed between said first and second ends that defines a recessed longitudinal portion along said main body configured to provide a low profile for clearance between adjacent connectors.

2. A tool according to claim 1, wherein
a relief portion is disposed in said main body opposite said recessed longitudinal portion.

3. A tool according to claim 1, wherein
said shaft includes one end coupled to said shaft and another end coupled to a handle.

4. A tool according to claim 1, wherein
said second end of said clasp includes a plurality of engagement members extending therefrom configured to engage the connector.

5. A tool according to claim 4, wherein
said engagement members are teeth adapted to engage corresponding grooves in the connector.

6. A tool for a connector, comprising:
a shaft; and
a clasp having a substantially semi-cylindrical cross-sectional shape, said clasp including a main body and opposite first and second ends, said first end being adapted to couple to said shaft, said second end being adapted to grasp a connector, said first end having a transverse diameter that is larger than a transverse diameter of said second end such that a step is disposed between said first and second ends that defines a recessed longitudinal portion along said main body configured to provide a low profile for clearance between adjacent connectors, and an enlarged opening being disposed in said recessed longitudinal portion of said main body that is configured to receive at least a portion of the connector.

7. A tool according to claim 6, wherein
said enlarged opening defines first and second elongated arms in said main body.

8. A tool according to claim 6, wherein
said enlarged opening is substantially oval in shape.

9. A tool according to claim 6, wherein
said shaft includes one end coupled to said shaft and another end coupled to a handle.

10. A tool according to claim 6, wherein
a relief portion is disposed in said main body opposite said recessed longitudinal portion.

11. A tool according to claim 6, wherein
said second end of said clasp includes a plurality of engagement members extending therefrom configured to engage the connector.

12. A tool for a connector, comprising:
a shaft; and
a clasp having a substantially semi-cylindrical cross-sectional shape, said clasp including a main body and opposite first and second ends, said first end being adapted to couple to said shaft, said second end being adapted to grasp a connector, said first end having a transverse diameter that is larger than a transverse diameter of said second end such that a step is disposed between said first and second ends that defines a recessed longitudinal portion along said main body configured to provide a low profile for clearance between adjacent connectors, and
said second end of said clasp including at least first and second engagement members configured to engage the connector, said first and second engagement members being located about 180 degrees apart from one another.

13. A tool according to claim 12, wherein
said first and second engagement members are first and second teeth extending from said second end that are adapted to engage corresponding grooves of the connector.

14. A tool according to claim 12, wherein
an enlarged opening is disposed in said recessed longitudinal portion of said main body that is configured to receive at least a portion of the connector.

15. A tool according to claim 14, wherein
said enlarged opening defines first and second elongated arms in said main body.

16. A tool according to claim 14, wherein
said enlarged opening is disposed closer to said second end of said clasp than said first end of said clasp.

17. A tool according to claim 12, wherein
said enlarged opening is substantially oval in shape.

18. A tool according to claim 12, wherein
said shaft includes one end coupled to said shaft and another end coupled to a handle.

19. A tool according to claim 12, wherein
a relief portion is disposed in said main body opposite said recessed longitudinal portion.

20. A tool according to claim 12, wherein
said first end of said clasp includes a notch for receiving an end of said shaft.
